(19) United States
(12) Patent Application Publication
(10) Pub. No.: US 2023/0301460 A1
(43) Pub. Date: Sep. 28, 2023

(54) Cooking Control Method and Apparatus Therefor

(71) Applicant: Shenzhen Hesung Innovation Technology Co., Ltd., Shenzhen (CN)

(72) Inventors: Huiqi HE, Shenzhen (CN); Peng CHEN, Shenzhen (CN); Peng LI, Shenzhen (CN); Lu CHEN, Shenzhen (CN); Nanfu ZHANG, Shenzhen (CN); Zaicheng YANG, Shenzhen (CN); Xiang CHEN, Shenzhen (CN); Peixiang TANG, Shenzhen (CN); Shangyu LI, Shenzhen (CN); Xianglu DAI, Shenzhen (CN); AiMin HE, Shenzhen (CN); Lihu WEI, Shenzhen (CN)

(21) Appl. No.: 17/868,754

(22) Filed: Jul. 19, 2022

(30) Foreign Application Priority Data
Mar. 23, 2022 (CN) 2022102924494

(51) Int. Cl. A47J 36/32; F24C 7/08; F24C 15/32; A23L 5/10

(52) U.S. Cl. CPC A47J 36/32; F24C 7/087; F24C 15/327; A23L 5/15; A47J 2202/00; A23V 2002/00

(57) ABSTRACT

A cooking control method of a cooking apparatus includes steps of heating a cooking chamber of the cooking apparatus to an ambient temperature by a heating unit of the cooking apparatus, detecting the ambient temperature of the cooking chamber, maintaining the ambient temperature of the cooking chamber, maintaining the ambient temperature of the cooking chamber at a predetermined set temperature by controlling the heating unit when the ambient temperature of the cooking chamber reaches the predetermined set temperature, detecting an inner temperature of an inner portion of the cooking object, and controlling the heating unit to heat the cooking chamber to maintain at an appropriate cooking temperature when the inner temperature of the cooking object reaches the appropriate cooking temperature so as to cook the cooking object at the appropriate cooking temperature in the cooking chamber.

### CROSS REFERENCE OF RELATED APPLICATION

This application is a non-provisional application that claims the benefit of priority under 35U.S.C. § 119(e) to a Chinese application, application number 2022102924494, filed Mar. 23, 2022, which is incorporated herewith by reference in its entirety.

### BACKGROUND OF THE PRESENT INVENTION

### Field of Invention

The present invention relates to cooking tool, and more particular to a cooking control method and apparatus for controlling the heating of the cooking object according to the temperature condition being monitored during the cooking process.

### Description of Related Arts

Air fryer is a cooking machine that utilizes hot air for “frying” operation, wherein hot air is used to replace the hot oil in the original frying pot to heat objects (such as chips, vegetables, meat, fish, and etc.), and to take away the moisture on the surface of the object through hot air to achieve the frying effect. Since the air fryer not only can greatly remove the grease in the object, but also maintain a lot of the demanded qualities of the fried object, such as the appearance of the fried object and etc., the air fryer is getting more and more popular and gaining much attention by the users that results great commercial value.

Currently, the traditional air fryer on the market usually has two operation modes for cooking food. The first operation mode is to directly select a pre-set recipe according to the type of food to be fried. Although this fool-style operation mode can greatly simplify the user's operation and being convenient for the user to use, it is impossible to pre-set all kinds of recipe for all types of food in advance. Practically, only a few common recipes can be predesignated and preset. The second operation mode is that the user manually sets the heating time and temperature according to the taste needs and experience, which certainly can get rid of the limitations of setting recipes, but it greatly relies on the user's experience. For most users, especially who are not the experienced or professional chefs, it is disastrous. In fact, even for culinary chefs, if they are new to using air fryers, they need to do lots of experiments and take many cooking attempts in order to get a considerable air frying effect.

The operation process of the conventional air fryer is usually to heat air by the heat energy generated from the electric heater thereof while the motor fan must be actuated to blow the air inside the air fryer at the same time so as to gradually increase the air temperature inside the air fryer. Then, when the internal air temperature is close to the upper limit of the designated temperature, the operation of the electric heater is stopped. At this time, a portion of the heat inside the air fryer was absorbed by the food, and the other portion of the heat was blown by the motor fan and lost. Thus, the air temperature inside the air fryer drops until the internal air temperature is close to the lower limit of the designated temperature, and then the electric heater is restarted to heat the air again. Therefore, the inner temperature of the air fryer increases and drops repeatedly in order to maintain the inner temperature of the air fryer at a certain level until the preset cooking time is reached. Then, the air fryer stops running to finish cooking the food. However, in the process of cooking, the temperature of the surface of the food and the temperature inside the food are different, so that it is often that the surface of the food has been cooked thoroughly but the inside of the food has not been well cooked, resulting a undercooked defect to the food after cooking, or that in order to ensure the inside of the food being well cooked, the cooking time has to be extended that generally causes serious water loss on the surface of the cooked food after the repeatedly heating to the food surface by the electric heater, leading to severe dehydration of the cooked food causing dry and hard taste that adversely affects the taste of food.

In other words, the air fryer is popular to the users due to its unique cooking method of using hot air to cook food. It has broad market prospects. However, its operation generally needs to rely on the implementation of set recipes to run. In addition, when the user customizes the operation of the air fryer, it is often difficult to reasonably set the heating time and temperature according to the natures and qualities of different kinds of food. Thus, it is difficult to achieve satisfactory cooking results. Also, since the conventional air fryer heats the food with hot air that generally heats the surface of the food firstly, it is a common problem of serve loss of surface moisture of the air-fried food no matter it is cooked based on the operation according to the recipe or the user's custom settings of the heating time and temperature, resulting in dry and hard food that seriously affects the taste of food.

### SUMMARY OF THE PRESENT INVENTION

The invention is advantageous in that it provides a cooking control method and apparatus therefor, wherein the heating of the cooking object is conducted under control according to the temperature condition of cooking object by monitoring of the temperature of the cooking object so as to ensure the doneness and taste of the cooked object.

Another advantage of the invention is to provide a cooking control method and apparatus therefor, which can substantially retain the moisture of the cooking food during the cooking process to avoid the cooked food being too dried and hard due to overlossing of water content in the cooked food so as to ensure the cooked food having a tender taste.

An advantage of the invention is to provide a cooking control method and apparatus therefor, wherein cooking condition of the cooking object is monitoring by checking and monitoring the inner temperature of the cooking object so as to ensure desired cooking effect that the cooked object can be well cooked to achieve the desired cooked state and the desired taste to meet the expected food doneness and taste.

An advantage of the invention is to provide a cooking control method and apparatus therefor, wherein a predetermined temperature is maintained until the inner temperature of the cooking object reached an appropriate cooking temperature, so as to avoid loss of moisture of the cooking object due to repeated heating and ensure the doneness and taste of the cooked object to meet the desired cooking effect.

An advantage of the present invention is to provide a cooking control method and apparatus therefor, wherein when the inner temperature of the cooking object reaches the appropriate predetermined cooking temperature, reduce the ambient temperature around the cooking object in the cooking apparatus to the appropriate predetermined cooking temperature, so as to ensure the surface temperature and the inner temperature of the cooking object being consistent, and that such consistent temperature condition is maintained until the cooking object is well cooked, thereby not only avoiding the defect of the undercooked of the inner portion of cooking object caused by the inconsistency of the surface temperature and the inner temperature thereof, but also preventing the defect of serve moisture loss of the surface portion of the cooling object caused by the overheating of the surface of the cooking object, in order to ensure the taste of the cooked object while it has been well cooked.

An advantage of the present invention is to provide a cooking control method and apparatus therefor, wherein the moisture of the cooking object is replenished during the process of waiting for the cooking object to be cooked that substantially ensures the desired cooking effect and taste of the cooked object as required by the user through the prevention of moisture loss due to heating.

An advantage of the present invention is to provide a cooking control method and apparatus therefor, wherein once the cooking object is cooked, the ambient temperature of the cooking object is rapidly increased, so as to rapidly rise the surface temperature of the cooking object until Maillard browning occurs, that is a brownish color or deeper crust on the surface of the cooking object is occurred, such that a bright appearance for the cooked object is presented that not only improves the aesthetics of the cooked object but also provides a special taste to meet the user's taste requirements.

An advantage of the present invention is to provide a cooking control method and apparatus therefor, wherein air flow of the cooking environment is enhanced during the process of increasing the ambient temperature of the cooking object, so that the cooking object can be more rapidly heated to improve the heating efficiency of the cooking object.

An advantage of the present invention is to provide a cooking control method and apparatus therefor, wherein the cooking apparatus comprises:
a housing having a cooking chamber therein for accommodating at least one cooking object;
a temperature sensing unit which comprises an ambient temperature sensing module for detecting an ambient temperature of the cooking chamber and a object temperature sensing module for detecting an inner temperature of the one or more cooking object;
a heating unit configured to generate heat for heating the cooking object in the cooking chamber; and
a control unit communicating and controlling the temperature sensing unit and the heating unit, wherein the control unit controls the heating of the heating unit according to the ambient temperature of the cooking chamber and the inner temperature of the cooking object so as to ensure a taste of the cooking object to meet the user's taste requirement.

An advantage of the present invention is to provide a cooking control method and apparatus therefor, wherein the control unit of the cooking apparatus is arranged to control the heating unit to stop further increasing the ambient temperature of the cooking chamber when the ambient temperature of the cooking chamber reaches a predetermined set temperature, such that the cooking object can be heated in the cooking chamber at the set temperature to avoid the cooking object from losing of moisture due to the repeatedly heating that adversely affects the taste of the cooked object. Thus, the cooking effect of the cooked object is ensured while meeting the taste requirements of the user.

An advantage of the present invention is to provide a cooking control method and apparatus therefor, wherein the control unit is arranged to control the heating unit to maintain the ambient temperature of the cooking chamber at an appropriate cooking temperature when the inner temperature of the cooking object reaches the appropriate cooking temperature so as to assure the surface temperature and the inner temperature of the cooking object to be cooked in such state in the cooking chamber are consistent, thereby avoiding a difference of the surface temperature and the inner temperature of the cooking object while cooking in the cooking chamber that often adversely affects the taste of the cooked object and other defects due to the inconsistency of every cooked portions of the cooking object, so as to ensure the preferred cooking effect and taste of the cooked object.

An advantage of the present invention is to provide a cooking control method and apparatus therefor, wherein the cooking apparatus further comprises a humidification unit configured for improving an ambient humidity of the cooking chamber so as to avoid excessive loss of moisture due to heating during the cooking process, thereby avoiding the cooked object taste hard due to excessive loss of water to ensure the desired taste of the cooked object.

An advantage of the present invention is to provide a cooking control method and apparatus therefor, wherein the humidification unit of the cooking apparatus is communicatively linked to and controlled by the control unit, and the work controlled by the control unit, wherein the control unit is arranged in the cooking chamber to control the humidification unit to enhance the ambient humidity of the cooking chamber while the ambient temperature of the cooking chamber is maintained at the appropriate cooking temperature, so as to ensure that the cooking chamber ambient humidity being maintained at a reasonable level during the cooking process of cooking object and thus avoids the cooking object being heated and cooked too dry and hard due to excessive loss of moisture to assure the desired taste of the cooked object.

According to the present invention, the foregoing and other objects and advantages are attained by a cooking control method, comprising steps of:
(A) heating a cooking chamber of a cooking apparatus to an ambient temperature by a heating unit of the cooking apparatus;
(B) detecting the ambient temperature of the cooking chamber of the cooking apparatus;
(C) maintaining the ambient temperature of the cooking chamber at a predetermined set temperature by controlling the heating unit in response to a condition that the ambient temperature of the cooking chamber reaches the predetermined set temperature;
(D) detecting an inner temperature of the cooking object until an inner temperature reaches an appropriate cooking temperature; and
(E) controlling the heating unit to heat the cooking chamber to maintain at the appropriate cooking temperature when the inner temperature of the cooking object reaches the appropriate cooking temperature, so as to cook the cooking object at the appropriate cooking temperature in the cooking chamber.

In one embodiment, the step (E) further comprises a step of:
(E.1) controlling an ambient humidity of the cooking chamber by means of the humidification unit of the cooking apparatus.

In one embodiment, the step (D) further comprises steps of:
(D.1) detecting inner temperature of an inner portion of the cooking object by a thermistor provided at a front end of a probe body of the object temperature sensing module of the cooking apparatus by inserting the probe body into the inner portion of the cooking object; and
(D.2) obtaining the inner temperature of the inner portion of the cooking object through the detection of a resistance value of the thermistor which varies with the inner temperature of the cooking object.

In one embodiment, the appropriate cooking temperature is determined according to the type of cooking object being cooked.

In one embodiment, the appropriate cooking temperature is ranged greater than or equal to 40° C. and less than or equal to 80° C.

In one embodiment, the cooking control method controls the heating unit by controlling a power supply switch of the heating unit.

In one embodiment, the cooking control method controls the heating unit by adjusting the current and/or the voltage of the heating unit.

In one embodiment, in the step (E.1), the ambient humidity of the cooking chamber is increased continuously by the humidification unit.

In one embodiment, in the step (E.1), the ambient humidity of the cooking chamber is increased intermittently by the humidification unit.

In one embodiment, the cooking control method further comprises steps of:
(F) controlling the heating unit to increase the ambient temperature of the cooking chamber when the cooking object is well cooked.

In one embodiment, in the step (A), the step (C), the step (E), and the step (F), an air flow unit is provided in cooking apparatus for controlling a driving of a flow of air in the cooking chamber.

In one embodiment, in the step (A), the step (C), and the step (E), the air flow unit is controlled at a low speed to drive the air flow in the cooking chamber.

In one embodiment, in the step (F), the air flow unit is controlled at a high speed to drive the air flow in the cooking chamber.

In accordance with another aspect of the invention, the present invention provides a cooking apparatus, comprising:
a main body, wherein said body having a cooking cavity for placing the cooking object;
a housing having a cooking chamber therein for accommodating at least one cooking object;
a temperature sensing unit which comprises an ambient temperature sensing module for detecting an ambient temperature of the cooking chamber and an object temperature sensing module for detecting an inner temperature of the one or more cooking object;
a heating unit configured to generate heat for heating the cooking object in the cooking chamber; and
a control unit communicating and controlling the temperature sensing unit and the heating unit, wherein the control unit controls the heating of the heating unit according to the ambient temperature of the cooking chamber and the inner temperature of the cooking object so as to ensure a taste of the cooking object to meet the user's taste requirement.

In one embodiment, the control unit is arranged to control the heating unit to stop further increasing the ambient temperature of the cooking chamber when the ambient temperature of the cooking chamber reaches a predetermined set temperature, such that the cooking object can be heated in the cooking chamber at the set temperature to avoid the cooking object from losing of moisture due to the repeatedly heating that adversely affects the taste of the cooked object. Thus, the cooking effect of the cooked object is ensured while meeting the taste requirements of the user.

In one embodiment, the control unit is arranged to control the heating unit to maintain the ambient temperature of the cooking chamber at an appropriate cooking temperature when the inner temperature of the cooking object reaches the appropriate cooking temperature so as to assure the surface temperature and the inner temperature of the cooking object to be cooked in such state in the cooking chamber are consistent, thereby avoiding a difference of the surface temperature and the inner temperature of the cooking object while cooking in the cooking chamber that often adversely affects the taste of the cooked object and other defects due to the inconsistency of every cooked portions of the cooking object, so as to ensure the preferred cooking effect and taste of the cooked object.

In one embodiment, the cooking apparatus further comprises a humidification unit configured for improving an ambient humidity of the cooking chamber so as to avoid excessive loss of moisture due to heating during the cooking process, thereby avoiding the cooked object taste hard due to excessive loss of water to ensure the desired taste of the cooked object.

In one embodiment, the humidification unit is communicatively linked to and controlled by the control unit, wherein the control unit is arranged in the cooking chamber to control the humidification unit to enhance the ambient humidity of the cooking chamber while the ambient temperature of the cooking chamber is maintained at the appropriate cooking temperature, so as to ensure that the cooking chamber ambient humidity being maintained at a reasonable level during the cooking process of cooking object and thus avoids the cooking object being heated and cooked too dry and hard due to excessive loss of moisture to assure the desired taste of the cooked object.

In one embodiment, the cooking apparatus is provided to have an initial heating state, a constant temperature heating state and a to-be-cooked heating state, wherein the cooking apparatus is arranged to be in the initial heating state after the cooking apparatus is activated to function and sequentially, when the ambient temperature of the cooking chamber reaches a predetermined set temperature detected by the ambient temperature sensing module, the cooking apparatus is arranged to be in the constant heating state, and that when the inner temperature of the cooking object reaches the appropriate cooking temperature, which is lower than the predetermined set temperature, detected by the object temperature sensing module, the cooking apparatus is arranged to be in the to-be-cooked heating state.

In one embodiment, the control unit is provided to control the heating unit to rapidly heat during the initial heating state to increase the ambient temperature of the cooking chamber to reach the predetermined set temperature.

In one embodiment, the control unit is arranged to control the heating unit during the constant temperature heating state to maintain the ambient temperature of the cooking chamber at the predetermined set temperature.

In one embodiment, the control unit is arranged to control the heating unit during the to-be-cooked heating state to maintain the ambient temperature of the cooking chamber at the appropriate cooking temperature.

In one embodiment of, the appropriate cooking temperature is determined according to the type of object to be cooked.

In one embodiment of, the appropriate cooking temperature is ranged greater than or equal to 40° C. and less than or equal to 80° C.

In one embodiment, the humidification unit is linked and communicated to the control unit, wherein the control unit is arranged to control the humidification unit to enhance the ambient humidity of the cooking chamber during the to-be-cooked heating state.

In one embodiment, the object temperature sensing module comprises a probe body, a thermistor provided at a front end of the probe body and a transmission element electrically connecting the thermistor to the control unit, wherein the probe body is configured to capable of inserting into the cooking object to place the thermistor inside the cooking object, such that a resistance value of the thermistor varies with the inner temperature of the cooking object and the inner temperature of the cooking object is transmitted to the control unit through the transmission element.

In one embodiment, the cooking apparatus is further arranged to have a coloring heating state, wherein when the ambient temperature of the cooking chamber during the to-be-cooked heating state reaches a predetermined set period of time, the cooking apparatus enters the coloring heating state that the control unit controls the heating unit to rapidly heat and increase the ambient temperature of the cooking chamber, wherein the predetermined set period of time is determined according to the type of cooking object.

In one embodiment, the cooking apparatus comprises an air flow unit, linked and communicated to the control unit, wherein the control unit is arranged to control the air flow unit to drive air flow in the cooking chamber.

In one embodiment, the control unit is arranged to control the heating unit by controlling an electrical power supply switch of the heating unit.

In one embodiment, the control unit is arranged to control the heating unit by adjusting an electric current and/or voltage of the heating unit.

In one embodiment, the humidification unit is configured to increase the ambient humidity of the cooking chamber in a continuous manner.

In one embodiment, the humidification unit is configured to increase the ambient humidity of the cooking chamber in an intermittent manner.

In one embodiment, the control unit is arranged to control the air flow unit at a low speed to drive the air flow in the cooking chamber during the initial heating state, the constant temperature heating state and the to-be-cooked heating state.

In one embodiment, the control unit is arranged to control the air flow unit at high speed to drive the flow of air in the cooking chamber during the coloring heating state.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow block diagram illustrating a cooking control method according to a preferred embodiment of the present invention.

FIG. 2 is a schematic view illustrating the cooking apparatus according to the above preferred embodiment of the present invention.

FIG. 3 is an exemplary view illustrating a working phase of the cooking apparatus according to the above preferred embodiment of the present invention.

FIG. 4 is a perspective view of an object sensing module of the cooking apparatus according to the above preferred embodiment of the present invention

The drawings, described above, are provided for purposes of illustration, and not of limitation, of the aspects and features of various examples of embodiments of the invention described herein. The drawings are not intended to limit the scope of the claimed invention in any aspect. For simplicity and clarity of illustration, elements shown in the drawings have not necessarily been drawn to scale and the dimensions of some of the elements may be exaggerated relative to other elements for clarity.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

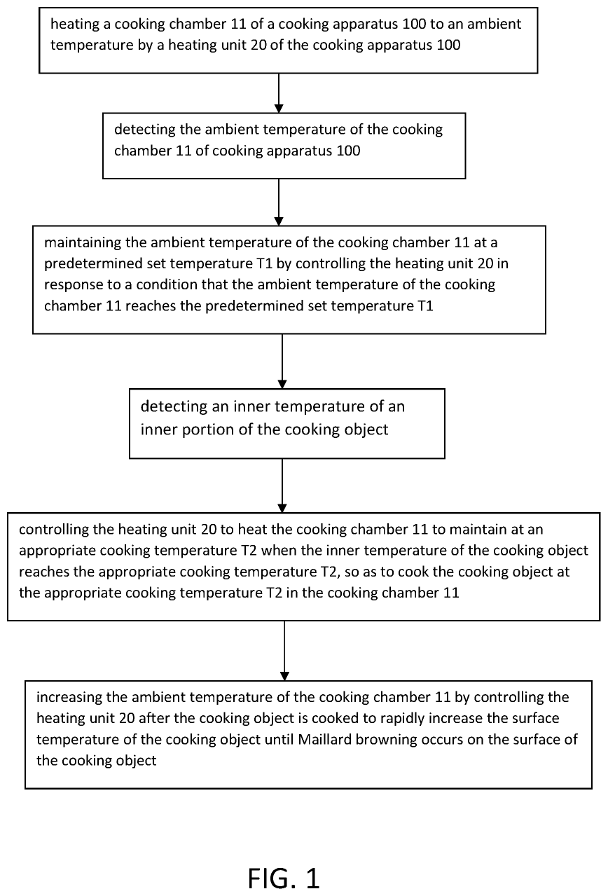

Referring to FIG. 1 of the drawings, a cooking control method according to a preferred embodiment is illustrated, wherein the cooking control method comprises steps of:
(A) heating a cooking chamber 11 of a cooking apparatus 100 to an ambient temperature by a heating unit 20 of the cooking apparatus 100;
(B) detecting the ambient temperature of the cooking chamber 11 of cooking apparatus 100;
(C) maintaining the ambient temperature of the cooking chamber 11 at a predetermined set temperature T1 by controlling the heating unit 20 in response to a condition that the ambient temperature of the cooking chamber 11 reaches the predetermined set temperature T1;
(D) detecting an inner temperature of an inner portion of the cooking object; and
(E) controlling the heating unit 20 to heat the cooking chamber 11 to maintain at an appropriate cooking temperature T2 when the inner temperature of the cooking object reaches the appropriate cooking temperature T2, so as to cook the cooking object at the appropriate cooking temperature T2 in the cooking chamber 11.

In particular, the cooking control method can monitor the temperature of the cooking object to be cooked in a way such as frying, wherein the temperature of the cooking chamber 11 is maintained at the appropriate cooking temperature T2 after the inner temperature of the cooking object reaches the appropriate cooking temperature, such that the cooking object can be cooked in an environment at a temperature of the appropriate cooking temperature T2 so as to ensure the surface temperature and the inner temperature of the cooking object to be maintained at a consistent temperature (i.e. the appropriate cooking temperature) to avoid an over loss of surface moisture of the cooking object due to a difference between the inner temperature and the surface temperature and affect the taste of the cooked object in order to ensure the cooking effect. It is worth mentioning that the cooking control method is suitable for cooking operations of various cooking apparatus such as ovens, air fryers and etc. Also, the cooking object adapted to be cooked by the cooking control method of the present invention can be food object such as potato fries or chips, vegetable, meats, fish, and etc.

In particular, the detection of the inner temperature of the cooking object in the step (D) is processed by means of an object temperature sensing module 32 of the cooking apparatus 100 of the present invention, wherein the step (D) further comprises steps of:
detecting the inner temperature of an inner portion of the cooking object by a thermistor 322 provided at a front end of a probe body 321 of the object temperature sensing module 32 of the cooking apparatus 100 by inserting the probe body 321 into the inner portion of the cooking object; and
(D.2) obtaining the inner temperature of the inner portion of the cooking object through the detection of a resistance value of the thermistor 322 which varies with the inner temperature of the cooking object.

It is worth mentioning that, in the step (A), the heating unit 20 is actuated to generate thermal energy for cooking operation, wherein the heat energy generated by the heating unit 20 is transferred to the air in the cooking chamber 11 so that the ambient temperature of the cooking chamber 11 increases correspondingly. In the step (C), when the ambient temperature of the cooking chamber 11 reaches the predetermined set temperature T1, the heating unit 20 is controlled by the control unit to maintain the ambient temperature of the cooking chamber at the predetermined set temperature T1. Specifically, the ambient temperature of the cooking chamber 11 can be maintained at the predetermined set temperature T1 by controlling a power supply of the heating unit 20. In other words, when the ambient temperature of the cooking chamber 11 rises and reaches the predetermined set temperature, a power supply loop of the heating unit 20 is disconnected to stop the running and operation of the heating unit 20, wherein when the ambient temperature of the cooking chamber 11 drops to lower than the predetermined set temperature due to the loss of heating source from the heating unit 20, the power supply loop of the heating unit 20 is switched on to supply heating energy to the cooking chamber 11 and the ambient temperature of the cooking chamber 11 rises back to the predetermined set temperature T 1, such that the ambient temperature of the cooking chamber 11 is maintained at the predetermined set temperature by means of the cycling of the switching on and off of the heating unit 20. It is understood that the predetermined set temperature T1 has no need to be a fixed value but preferred to be a temperature range having an upper limit and a lower limit, such that when the ambient temperature of the cooking chamber 11 reaches the upper limit of the predetermined set temperature T1, heating unit 20 is stopped to operate and produce heat, and that when the ambient temperature of the cooking chamber 11 is lower than or equal to the lower limit of the predetermined set temperature T1, the operation of the heating unit 20 is resumed, wherein a preferred temperature range difference between the upper limit and lower limit of the predetermined set temperature T1 is less than or equal to 10° C., so as to avoid the ambient temperature of the cooking chamber 11 is repeatedly increased frequency to prevent the loss of moisture of the cooking object and thus to ensure the taste of the cooked food.

In particular, in an alternative mode of the preferred embodiment of the present invention, the control of the heating unit 20 may also be accomplished by adjusting an electric current and/or voltage of the heating unit 20, thereby maintaining the ambient temperature of the cooking chamber 11 at the predetermined set temperature T1, i.e. by adjusting the electric current and/or voltage of the heating unit 20 to achieve a heating power supply adjustment of the heating unit 20. As in the step (A), by increasing the electric current and/or voltage of the heating unit 20, the heating energy produced by the heating unit 20 is increased correspondingly, so that the ambient temperature of the cooking chamber 11 can quickly reach the predetermined set temperature T1. In the step (C), by reducing the electric current and/or voltage of the heating unit 20, the heating energy produced by the heating unit 20 is reduced to avoid further increasing the ambient temperature of the cooking chamber 11 so as to significantly maintain the ambient temperature of the cooking chamber 11 at the predetermined set temperature T1.

It is worth mentioning that the appropriate cooking temperature T2 is determined according to the type of cooking object. In other words, when the cooking control method is processed to cook different types of food object, the appropriate cooking temperature T2 would be determined according to the specific type of cooking object to be cooked. For example, when the cooking object is meat, the appropriate cooking temperature is preferred to be set to trend to 70° C. to ensure the cooking object to be cooked at this temperature and not be overcooked at this temperature, so as to ensure the taste of the cooking object. Also, when the cooking object is vegetable, the appropriate cooking temperature T2 is preferred to be set to tend to 60° C. to ensure the cooking effect.

In other words, the appropriate cooking temperature T2 is determined according to the type of cooking object and the appropriate cooking temperature T2 is generally not a fixed value. Preferably, the appropriate cooking temperature is set to temperature range (greater than or equal to) ≥40° C. and (less than or equal to) ≤80 ° C., such that the cooking object is able to be cooked within this temperature range that the cooking object is heated within this temperature range while maintaining the moisture of the cooking object. Thus, excessive temperature heating and loss of moisture of the cooking object are avoided, so as to meet the cooking needs and taste requirements and to prevent the cooked object being too dry and hard.

In particular, in the step (E), the ambient temperature of the cooking chamber 11 is maintained at the appropriate cooking temperature T2 so that the cooking object is cooked in the heated cooking chamber 11 at the cooking temperature T2, that is, in this state, the surface heating temperature of the cooking object is consistent with the inner temperature of cooking object and the cooking object is gradually cooking until cooked, thereby substantially avoiding that the inner portion of the cooking object is undercooked when the outer portion of the cooking object is well cooked, or that the inner portion of the cooking object is well cooked but the outer portion of the cooking object is overcooked, which are caused by the inconsistency of the surface heating temperature and the internal heating temperature of the cooking object. In addition, it also prevents the excessive heating to the surface of the cooking object that results in a serious loss of surface moisture. Accordingly, the taste of the cooking object is guaranteed while it is nicely cooked.

It is worth mentioning that some cooking objects may not need to be fully cooked. The cooking state of the cooking object can be predetermined and set according to the type of the cooking object and the user's taste and requirement. Accordingly, the description “well cooked” in the present invention may refer to the cooked state desired by the user, such as rare, medium rare, medium, fully cooked, and the like when the cooking object is steak. The present invention should not be limited to the state of cooking.

In particular, in order to further prevent excessive loss of moisture during the cooking process of the cooking object, to avoid the cooking object being cooked overly dry and hard, and to ensure that the cooked object can have a tender taste, the step (E), further comprises steps of:
(E.1) increasing the ambient humidity of the cooking chamber 11 by a humidification unit 50 which is controlled by the control unit 40 of the cooking apparatus 100.

Specifically, the humidification unit 50 is configured to spray water mist in the cooking chamber 11 to increase the ambient humidity of the cooking chamber 11, so that during the cooking object being cooking at the appropriate cooking temperature T2, the heat produced in the cooking chamber 11 would mainly evaporate moisture in the cooking chamber 11, i.e. the water mist sprayed from the humidification unit 50 instead of the moisture of the cooking object, and thus the evaporation of the water content of the cooking object is greatly reduced, thereby avoiding excessive loss of moisture of the cooking object that generally causes the cooking object to taste dry and hard. Therefore, it facilitates the cooking process in the cooking chamber 11 effectively and ensures the desired taste of the cooking object.

It is worth mentioning that a humidification mode of the humidification unit 50 may be set according to the type of cooking object and/or the desired taste of cooking object to the user. As when the cooking object is a vegetable, the humidification unit 50 is preferred continuously increases the ambient humidity of the cooking chamber 11, such that the continuous supplement of the ambient humidity in the cooking chamber 11 substantially reduces the moisture loss of the cooking object so as to ensure that the cooking object has a tender taste. When the cooking object is French fries, the humidification unit 50 to the cooking chamber 11 is preferred to increase the ambient humidity in the cooking chamber 11 intermittently, such that the intermittent replenishment of the ambient humidity of the cooking chamber 11 substantially avoids, excessive loss of moisture of the cooking object, resulting that the cooking object can form a crispy taste to meet the user's taste requirements.

Further, in order to improve the aesthetic degree of the cooking object and to meet the user's requirements for taste, the cooking control method further comprises steps of:
(F) increasing the ambient temperature of the cooking chamber 11 by controlling the heating unit 20 after the cooking object is cooked to rapidly increase the surface temperature of the cooking object until Maillard browning occurs on the surface of the cooking object.

Specifically, the cooking object is cooked within an environment at the appropriate cooking temperature T2, i.e. the cooking chamber 11 being maintained in the appropriate cooking temperature T2 by the heating unit 20, while the supplement to the ambient humidity in the cooking chamber 11 in the step (E.1), so that the moisture of the cooking object after cooked is maintained ensuring the cooked object has the desired tender taste. At this time, the heating unit 20 is further controlled to rapidly increase the ambient temperature of the cooking chamber 11 so as to rapidly rise the surface temperature of the cooking object until Maillard browning occurs, that is a brownish color or deeper crust on the surface of the cooking object is occurred, such that a bright appearance for the cooked object is presented after the step (F), that not only improves the aesthetics of the cooked object but also provides a special taste to meet the user's taste requirements. In other words, due to the rapid increase of the surface temperature of the cooking object, a crispy taste of the cooking object is achieved while the inner portion of the cooking object remains a fresh and tender taste since it was cooked in the environment under the appropriate cooking temperature T2 with the replenishment of the moisture in the cooking chamber 11 for the inner portion of the cooking object by the humidification unit 50. Accordingly, the cooked object obtained after the step (F) can have a preferred taste of crispy outside and tender inside to fulfill the preferred taste requirement of the user.

Further, in order to enhance the cooking efficiency of the cooking control method and to ensure the degree of heat uniformity of the cooking object, the cooking control method further comprises a step of circulating an air flow in the cooking chamber 11 by means of an air flow unit 60 during the step (A), the step (C), the step (E), and the step (F), wherein the air flow unit 60 is configured and operated to drive a flow of air in the cooking chamber 11.

In particular, based on air driving and ventilating by the air flow unit 60, the thermal energy generated by the heating unit 20 can be rapidly transmitted in the cooking chamber 11 through the heated hot air that significantly and promptly increases the ambient temperature of the cooking chamber 11 so as to improve the heating efficiency of cooking object. In addition, the well ventilation and circulation of hot air in the cooking chamber 11 by means of the air flow driving of the air flow unit 60, the hot air can be evenly and well contacting with the entire surface of the cooking object for ensuring the desired cooking effect efficiently.

It is worth mentioning that the flow of air in the cooking chamber 11 contains the water moisture for the cooking object to be cooked therein and thus the taste of the cooking object can be ensured. In particular, during the step (A), the step (C) and the step (E), the air flow unit 60 is controlled in low-speed to drive the air flow in the cooking chamber 11 in order to improve the ambient temperature rising efficiency of the cooking chamber 11 while avoiding high-speed circulation of air and a large amount of moisture on the surface of the cooking object being removed with high-speed air that would cause the cooking object becoming dry and hard, and to ensure a heat uniformity of the cooking object. Further, in the step (F), the air flow unit 60 is controlled to drive the air flow in the cooking chamber 11 at high speed to rapidly increase the ambient temperature in the cooking chamber 11 so as to have a prompt rise of the surface temperature of the cooking object rapidly, such that due to the high-speed circulation of air, the surface moisture of the cooking object can be rapidly reduced, thereby facilitating the Maillard browning effect to the surface of the cooking object for the aesthetics of the cooking object. Accordingly, the cooking control method of the present invention ensures the desired taste and appearance of the cooking object at the same time.

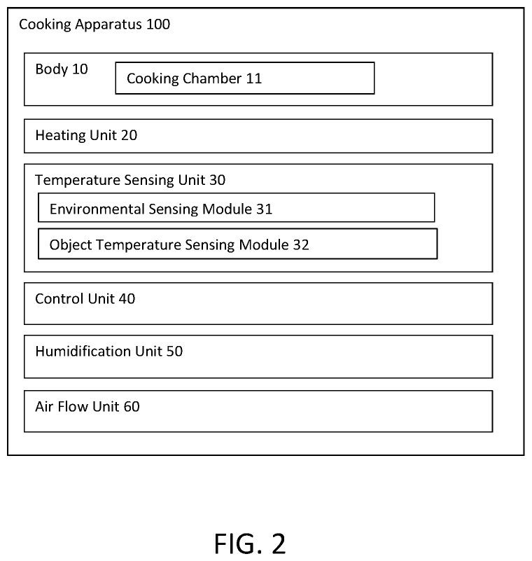

Referring to FIG. 2, the cooking apparatus 100 according to the preferred embodiment of the present invention comprises a body 10, the heating unit 20, a temperature sensing unit 30, and a control unit 40. The body 10 has the cooking chamber 11 provided therein for containing the cooking object 11 to be cooked. The heating unit 20 can be electric heater installed in the body 10 to produce thermal energy to heat the cooking chamber 11 in predetermined and controllable manner by adjusting the ambient temperature of the cooking chamber 11. The temperature sensing unit 30 includes an ambient temperature sensing module 31 and an object temperature sensing module 32, wherein the ambient temperature sensing module 31 is installed in the body 10 and electrically connected with the control unit 40 to detect the ambient temperature of the cooking chamber 11, and the object temperature sensing module 32 is electrically connected with the control unit 40 for detecting the inner temperature of the cooking object. The temperature sensing unit 30 and the heating unit 20 are electrically connected and communicated to the control unit 40, wherein the control unit 40 is provided to control the heating work of the heating unit 20 according to the ambient temperature of the cooking chamber 11 and the inner temperature of the cooking object. Thus, based on the temperature of the detection results corresponding to the regulation of the cooking temperature to ensure the cooking effect, such that the cooking object can reach the desired state of ripeness and the desired taste after being cooked.

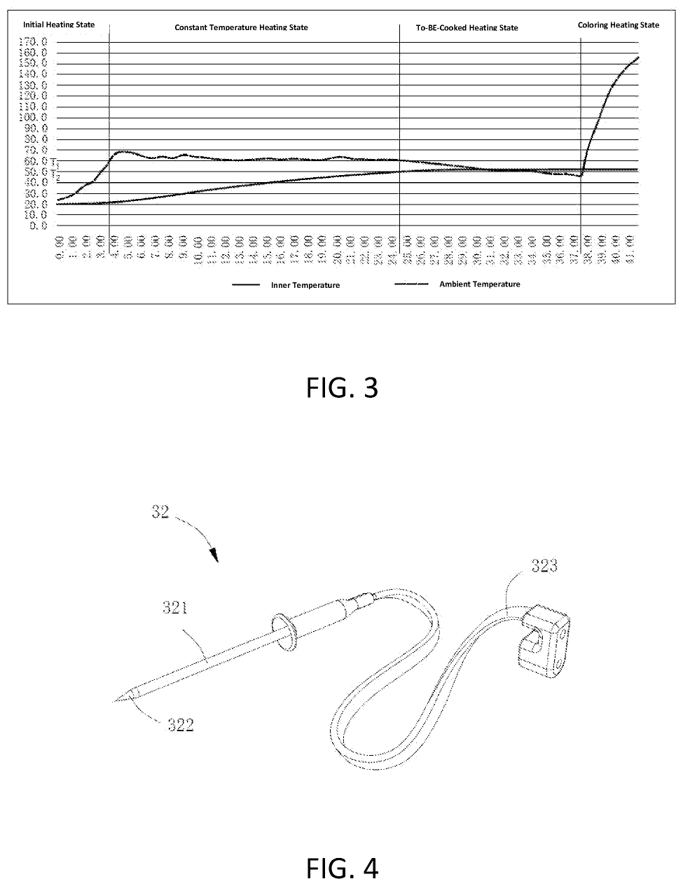

Specifically, referring to FIG. 3, the cooking apparatus 100 is arranged to be operated with an initial heating state, a constant temperature heating state and a to-be-cooked heating state. Upon actuation of the cooking apparatus 100 to function, the cooking apparatus is arranged in the initial heating state. Then, sequentially, the cooking apparatus 100 is arranged to enter the constant temperature heating state once the ambient temperature of the cooking chamber 11 detected by the ambient temperature sensing module 31 reaches the predetermined set temperature T1, and the cooking apparatus 100 is arranged to enter the to-be-cooked heating state once the inner temperature of the cooking object detected by the object temperature sensing module 32 reaches the appropriate cooking temperature T2, wherein while the appropriate cooking temperature T2 is lower than the set temperature T1, the cooking object is cooked in the to-be-cooked heating state, such that the inner temperature and surface temperature of the cooking object can be maintained consistent to avoid serve and over loss of surface moisture of the cooking object due to the difference in inner temperature and surface temperature that may adversely affect the taste of the cooking object so as to ensure the desired cooking effect.

It is worth mentioning that the object temperature sensing module 32, which is used to detect the inner temperature of the inner portion of the cooking object, as shown in FIG. 4, includes a probe body 321, a thermistor 322 provided at a front end of the probe body 321 and a transmission element 323 configured to be electrically connected to the thermistor 322 and the control unit 40, wherein the thermistor 322 is configured to be inserted into the inner portion of the cooking object for detecting the inner temperature of the inner portion of the cooking object, wherein a resistance value of the thermistor 322 varies with the inner temperature of the cooking object and continuously transmits the current inner temperature of the cooking object to the control unit 40 via the transmission element 322.

In particular, the control unit 40 is arranged to control the heating unit 20 to rapidly heating up the cooking chamber 11 to gradually increase the ambient temperature of the cooking temperature during the initial heating state until the ambient temperature reaches the predetermined set temperature T1, wherein the heating unit 20 generates heat and transfer the heat to the air in the cooking chamber 11, so that the ambient temperature of the cooking chamber 11 rises correspondingly. When the ambient temperature of the cooking chamber 11 reaches the predetermined set temperature T1, the cooking apparatus 100 is switched to the constant temperature heating state, wherein the control unit 40 is arranged to control the heating unit 20 to produce more or less thermal energy correspondingly so as to maintain the ambient temperature of the cooking chamber 11 remaining at the predetermined set temperature T1 so that the cooking object is heated continuously at the predetermined set temperature T1 until the inner temperature of the inner portion of the cooking object is detected reaching the appropriate cooking temperature T2, and then the cooking apparatus switches into the to-be-cooked heating state, wherein the control unit 40 is arranged to control the heating unit 20 to produce adequate thermal energy to the cooking chamber 11 to maintain the ambient temperature of the cooking chamber 11 at the appropriate cooking temperature T2 so as to cook the cooking object at the appropriate cooking temperature T2. It is appreciated that, in the to-be-cooked heating state, the surface temperature of the surface portion and the inner temperature of the inner portion of the cooking object remain consistent, so as to avoid the defective that the inner portion of the cooking object is not under cooked while the surface portion of the cooking object is well cooked or over cooked due to the inconsistent of the surface temperature and the inner temperature of the cooking object being cooking, while also preventing the defective that the inner portion of the cooking object is well cooked but the surface of the cooking object is overcooked causing serve moisture loss in surface portion of the cooking object, thereby ensuring the taste of the cooking object while it is nicely and fully cooked at the same time.

It is appreciated that the heating unit 20 may be implemented to comprise heating element such as an electric heating tube, an electric heating plate, an electric heating wire, an electric heating film, and etc. that is capable of converting electrical energy into thermal energy to produce heat to the cooking chamber 11, wherein the control unit 40 can control the thermal energy supply of the heating unit 20 by controlling the power supply to the heating unit 20, such as by controlling the connecting or disconnecting of the power supply loop of the heating unit 20, i.e. to turn on or turn off of the heating unit 20. Alternatively, the control unit 40 may also control the thermal energy supply of the heating unit 20 by controlling the electrical current and/or voltage of the power supply of the heating unit 20, i.e. to adjust the power supply current and/or voltage of the heating unit 20 to achieve a heating power regulation of the heating unit 20.

Further, the cooking apparatus 100 includes a humidification unit 50 which is electrically connected and communicated with the control unit 40. The control unit 40 is arranged to control the humidification unit 50, especially during the to-be-cooked heating state to increase the ambient humidity of the cooking chamber 11, so as to avoid excessive loss of moisture of the cooking object due to the heating of the cooking object by increasing the environmental humidity of the cooking chamber 11, especially preventing the water content in the surface portion of the cooking object to be excessively evaporated due to the heating during the gradually cooking process so as to prevent the cooking object from being cooked too dry and hard to excessive loss of water content of the cooking object, thereby ensuring the taste of the cooking object.

In particular, the humidification unit 50 can be implemented by spraying water mist in the cooking chamber 11 to increase the ambient humidity thereof, for example, but not limited to, producing the water mist by means of ultrasonic atomization of the cooking chamber 11, by spraying water mist through a water pump, and etc. to increase the ambient humidity of the cooking chamber 11.

It is worth mentioning that the cooking apparatus 100 is capable of being processed in a coloring heating state, wherein the cooking apparatus 100 is arranged to enter the coloring heating state after the to-be-cooked heating state is operated for a predetermined set time which is determined according to the type of cooking object to be cooked. In the coloring heating state, the control unit 40 is arranged to control the heating unit 20 to rapidly heat the cooking chamber 11 to increase the ambient temperature of the cooking chamber 11 rapidly so as to promptly heat the surface portion of the cooking object to increase the surface temperature thereof rapidly until Maillard browning occurs, that is a brownish color or deeper crust on the surface of the cooking object is occurred, such that a bright appearance for the cooked object is presented that not only improves the aesthetics of the cooked object but also provides a special taste to meet the user's taste requirement as well as the practicality of the cooking apparatus 100.

Further, the cooking apparatus 100 includes an air flow unit 60 which is electrically connected and communicated with the control unit 40. The control unit 20 is arranged to control the air flow unit 60 driving air flow in the cooking chamber 11, thereby increasing the cooking efficiency of the cooking apparatus 100. The air flow driven by the air flow unit 60 ensures the degree of heat uniformity of the cooking object. In particular, the control unit 40 is arranged to control the air flow unit 60 to drive the air flow in low speed in the cooking chamber 11 during the initial heating state, the constant temperature heating state and the to-be-cooked heating state, so as to ensure that the water content and moisture of the cooking object would not be excessively lost while enhancing the ambient temperature rising efficiency of the cooking chamber 11 and the heat uniformity in the cooking chamber 11 with respect to the cooking object being cooked therein. In addition, the control unit 40 is arranged to drive the air flow at high speed in the cooking chamber 11 during the coloring heating state, so as to promptly increase the ambient temperature of the cooking chamber 11 to rapidly increase the surface temperature of the cooking object to rapidly heat the surface of the cooking object for facilitating the Maillard browning and coloring the surface of the cooking object by promptly reducing only the surface moisture of the cooking object by the high speed air circulation of air in the cooking chamber 11 for coking and coloring without losing water content of the inner portion of the cooking object for coking and coloring.

It is worth mentioning that, according to the preferred embodiment of the present invention, the air flow unit 60 can be implemented as, but not limited to, a fan installed in the cooking chamber 11 of the body 10 for driving air flow in the cooking chamber 11, wherein when the air flow unit 60 is turned on, the air is directly blown and fanned to ventilate and circulate in the cooking chamber 11. In some embodiments, the air flow unit 60 may also be implemented as a fan installed outside the cooking chamber 11 and communicating with the cooking chamber 11 via an air circulation channel for driving air flowing in the cooking chamber 11 in a circulating manner.

It should be understood that the cooking apparatus 100 is allowed to be implemented as air fryer, oven and other cooking equipment that the present invention should not be limited.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-38 (canceled)

39. A method of controlling an ambient humidity of a cooking chamber of an air fryer for cooking at least a cooking object in the cooking chamber, comprising steps of:
(i) detecting an inner temperature of an inner portion of the cooking object after an ambient temperature of the cooking chamber of the air fryer is detected and maintained at a predetermined set temperature by controlling a heating unit in response to a condition that the ambient temperature of the cooking chamber reaches the predetermined set temperature, wherein the heating unit generates thermal energy, which is transmitted to an air flow in the cooking chamber, and is controlled by a control unit to maintain the ambient temperature of the cooking chamber at the predetermined set temperature;
(ii) maintaining the cooking chamber at an appropriate cooking temperature, greater than or equal to 40° C. and less than or equal to 80° C., by controlling the heating unit to heat the air flow of the cooking chamber when the inner temperature of the cooking object reaches the appropriate cooking temperature, and spraying a water mist on a surface of the cooking object in the cooking chamber to avoid excessive heating of the surface of the cooking object and an over loss of surface moisture in a surface portion of the cooking object while the cooking object being cooking at the appropriate cooking temperature such that a surface temperature and the inner temperature of the cooking object are maintained at the appropriate cooking temperature for a predetermined set period of time to gradually cook the cooking object until the cooking object is cooked; and
(iii) increasing a speed of the air flow to be heated by the heating unit to contact with the surface of the cooking object in the cooking chamber without spraying the water mist to increase the surface temperature of the cooking object until Maillard browning occurs on the surface of the cooking object.

40. The method, as recited in claim 39, wherein, in the step (ii), the water mist is sprayed on the surface of the cooking object in the cooking chamber by a humidification unit which is controlled by the control unit of the air fryer.

41. The method, as recited in claim 40, wherein, in the step (ii), the humidification unit comprises a water pump spraying the water mist.

42. The method, as recited in claim 39, further comprising a step of circulating an air flow in the cooking chamber by an air flow unit which is configured and operated to drive the air flow in the cooking chamber, such that the thermal energy generated by the heating unit is transmitted in the cooking chamber to heat the air flow in the cooking chamber.

43. The method, as recited in claim 40, further comprising a step of circulating an air flow in the cooking chamber by an air flow unit which is configured and operated to drive the air flow in the cooking chamber, such that the thermal energy generated by the heating unit is transmitted in the cooking chamber to heat the air flow in the cooking chamber.

44. The method, as recited in claim 41, further comprising a step of circulating an air flow in the cooking chamber by an air flow unit which is configured and operated to drive the air flow in the cooking chamber, such that the thermal energy generated by the heating unit is transmitted in the cooking chamber to heat the air flow in the cooking chamber.

45. The method, as recited in claim 42, wherein, during the step (i) and the step (ii), the air flow unit is controlled in low-speed to drive the air flow in the cooking chamber, wherein, during the step (iii), the air flow unit is controlled in high speed to drive the drive the air flow in the cooking chamber to rapidly increase the ambient temperature of the cooking chamber.

46. The method, as recited in claim 43, wherein, during the step (i) and the step (ii), the air flow unit is controlled in low-speed to drive the air flow in the cooking chamber, wherein, during the step (iii), the air flow unit is controlled in high speed to drive the drive the air flow in the cooking chamber to rapidly increase the ambient temperature of the cooking chamber.

47. The method, as recited in claim 44, wherein, during the step (i) and the step (ii), the air flow unit is controlled in low-speed to drive the air flow in the cooking chamber, wherein, during the step (iii), the air flow unit is controlled in high speed to drive the drive the air flow in the cooking chamber to rapidly increase the ambient temperature of the cooking chamber.

48. The method, as recited in claim 39, wherein, in the step (i), the inner temperature of the inner portion of the cooking object is detected by an object temperature sensing module through inserting a thermistor provided at a front end of a probe body of the object temperature sensing module into the inner portion of the cooking object, and the ambient temperature of the cooking chamber is detected by an ambient temperature sensing module installed in a body of the air fryer, wherein the object temperature sensing module and the ambient temperature sensing module are electrically connected with the control unit.

49. The method, as recited in claim 42, wherein, in the step (i), the inner temperature of the inner portion of the cooking object is detected by an object temperature sensing module through inserting a thermistor provided at a front end of a probe body of the object temperature sensing module into the inner portion of the cooking object, and the ambient temperature of the cooking chamber is detected by an ambient temperature sensing module installed in a body of the air fryer, wherein the object temperature sensing module and the ambient temperature sensing module are electrically connected with the control unit.

50. The method, as recited in claim 45, wherein, in the step (i), the inner temperature of the inner portion of the cooking object is detected by an object temperature sensing module through inserting a thermistor provided at a front end of a probe body of the object temperature sensing module into the inner portion of the cooking object, and the ambient temperature of the cooking chamber is detected by an ambient temperature sensing module installed in a body of the air fryer, wherein the object temperature sensing module and the ambient temperature sensing module are electrically connected with the control unit.

51. The method, as recited in claim 47, wherein, in the step (i), the inner temperature of the inner portion of the cooking object is detected by an object temperature sensing module through inserting a thermistor provided at a front end of a probe body of the object temperature sensing module into the inner portion of the cooking object, and the ambient temperature of the cooking chamber is detected by an ambient temperature sensing module installed in a body of the air fryer, wherein the object temperature sensing module and the ambient temperature sensing module are electrically connected with the control unit.

52. The method, as recited in claim 48, wherein the inner temperature of the inner portion of the cooking object is obtained through a detection of a resistance value of the thermistor value of the thermistor.

53. The method, as recited in claim 49, wherein the inner temperature of the inner portion of the cooking object is obtained through a detection of a resistance value of the thermistor value of the thermistor.

54. The method, as recited in claim 50, wherein the inner temperature of the inner portion of the cooking object is obtained through a detection of a resistance value of the thermistor value of the thermistor.

55. The method, as recited in claim 51, wherein the inner temperature of the inner portion of the cooking object is obtained through a detection of a resistance value of the thermistor value of the thermistor.

56. The method, as recited in claim 39, wherein the ambient temperature of the cooking chamber is maintained at the predetermined set temperature by controlling a power supply of the heating unit, such that when the ambient temperature of the cooking chamber rises and reaches the predetermined set temperature, a power supply loop of the heating unit is switched off to stop a running and operation of the heating unit, and when the ambient temperature of the cooking chamber drops to lower than the predetermined set temperature, the power supply loop of the heating unit is switched on to supply the thermal energy to the cooking chamber and the ambient temperature of the cooking chamber rises back to the predetermined set temperature, so that the ambient temperature of the cooking chamber is maintained at the predetermined set temperature by mean of a cycling of switching on and off of the power supply loop of the heating unit.

57. The method, as recited in claim 42, wherein the ambient temperature of the cooking chamber is maintained at the predetermined set temperature by controlling a power supply of the heating unit, such that when the ambient temperature of the cooking chamber rises and reaches the predetermined set temperature, a power supply loop of the heating unit is switched off to stop a running and operation of the heating unit, and when the ambient temperature of the cooking chamber drops to lower than the predetermined set temperature, the power supply loop of the heating unit is switched on to supply the thermal energy to the cooking chamber and the ambient temperature of the cooking chamber rises back to the predetermined set temperature, so that the ambient temperature of the cooking chamber is maintained at the predetermined set temperature by mean of a cycling of switching on and off of the power supply loop of the heating unit.

58. The method, as recited in claim 49, wherein the ambient temperature of the cooking chamber is maintained at the predetermined set temperature by controlling a power supply of the heating unit, such that when the ambient temperature of the cooking chamber rises and reaches the predetermined set temperature, a power supply loop of the heating unit is switched off to stop a running and operation of the heating unit, and when the ambient temperature of the cooking chamber drops to lower than the predetermined set temperature, the power supply loop of the heating unit is switched on to supply the thermal energy to the cooking chamber and the ambient temperature of the cooking chamber rises back to the predetermined set temperature, so that the ambient temperature of the cooking chamber is maintained at the predetermined set temperature by mean of a cycling of switching on and off of the power supply loop of the heating unit.
